(19) United States
(12) Patent Application Publication
(10) Pub. No.: US 2019/0234645 A1
(43) Pub. Date: Aug. 1, 2019

(54) STERILE AIRFLOW DELIVERY SYSTEM

(71) Applicant: Jonathan Haar, Cambridge, MA (US)

(72) Inventor: Jonathan Haar, Cambridge, MA (US)

(21) Appl. No.: 16/260,992

(22) Filed: Jan. 29, 2019

Related U.S. Application Data
(60) Provisional application No. 62/623,196, filed on Jan. 29, 2018.

(51) Int. Cl. F24F 13/078; A61G 13/10; F24F 7/06

(52) U.S. Cl. CPC F24F 13/078; F24F 2007/001; F24F 7/06; A61G 13/108

(57) ABSTRACT

A system for providing laminar airflow over an operating platform having a top surface and a base. The system includes an airflow delivery apparatus and a return plenum. The airflow delivery apparatus is positioned above the top surface of the operating platform and includes a light assembly and a plurality of vents. The light assembly is configured to direct light toward the operating table. The plurality of vents is positioned around the light source and configured to direct airflow toward the top surface of the operating platform. The return plenum is positioned in the base of the operating platform below the top surface and is configured to receive airflow from around the operating platform in order to achieve laminar airflow around the operating platform.

### CROSS-REFERENCE TO RELATED APPLICATIONS

The present non-provisional patent application claims priority to U.S. provisional patent application titled “LAMINAR FLOW STERILE AIR DELIVERY SYSTEM”, Ser. No. 62/623,196, filed Jan. 29, 2018, the entirety of which is hereby incorporated by reference into this non-provisional patent application.

### BACKGROUND

Surgical suites, such as hospital emergency rooms (ERs) and operating rooms (ORs), are among the most infection-sensitive environments in healthcare facilities. Surgical procedures increase patient vulnerability to pathogens transmitted from surgical personnel, surgical equipment, contaminated air, and the patient's own skin flora.

Despite advancements in surgical techniques and infection-prevention methods, surgical-site infections (SSIs) persist. As used herein, the term surgical “site” is used to mean the location on the patient where surgery is being performed (e.g., the surgical wound). Squames, or skin flakes or scales, are one of the primary sources of bacteria-causing SSIs transmitted to the surgical site through the air. Numerous squames are generated in a typical surgical procedure, despite hygiene-related prevention measures. SSIs can cause morbidity, extended hospital stays, extended post-operative recovery, and even mortality.

To address the contaminate spread, some surgical suites are equipped with systems utilizing high-efficiency particulate air (HEPA) filters and air handlers equipped with conditioning, re-heating devices, and humidity control. However, SS's caused by self-contaminating squames and pathogen introduction are not necessarily prevented by increasing filtering and the flow of air within the surgical suite. Increased airflow in a surgical suite may dilute site-specific contamination, but will result in the spread of contaminants throughout the surgical suite, which are often transmitted to subsequent patients using the surgical suite. The contaminants may also enter hallways and land on surgical equipment for use on other patients. Further, increasing general airflow will result in entraining the contaminants around the patient.

Furthermore, surgical suites often include a multitude of obstructions to the airflow. The obstructions may include arrays of monitor screens closely positioned around patients, separate screens reading out the patient vitals, fluoroscope heads to render images, and sometimes two fluoroscope heads to provide 3D imaging, surgical lights positioned over patients, rings of carts with monitoring equipment of various heights and sizes, and large anesthetic dispensing machines connected to the ceiling. Additionally, surgeons may be attended by other doctors, residents, scrub nurses or other technicians, and anesthesiologists, who all cluster around the surgical suite.

Such obstructions can interfere with the airflow around the patient. Furthermore, such a setup may create a static pressure pocket of stagnant air over and around the patient. In addition, eddies of semi-sterile air often travel across the procedure surface area after passing over unclean equipment surfaces. Further, personnel and equipment entering and leaving through doors of surgical suites can change the pressures of the surgical suites from positive to negative many times during the course of an operation. This added turbulence also disrupts the airflow.

The background discussion is intended to provide information related to the present invention which is not necessarily prior art.

### SUMMARY

The present invention solves the above-described problems and other problems by providing an improved system for providing laminar airflow over an operating platform having a base.

A system constructed in accordance with an embodiment of the present invention broadly comprises an airflow delivery apparatus and a return inlet. The airflow delivery apparatus is positioned above the operating platform and includes a lighting assembly and a plurality of vents. The lighting assembly is configured to direct light toward the operating platform. The vents are positioned around the light source and are configured to direct airflow toward the operating platform.

The return inlet is positioned on the base of the operating platform and is configured to receive airflow from around the operating platform. By being positioned on the base of the operating platform, the system is configured to provide laminar airflow across the operating platform, thereby more effectively removing contaminants, such as squames. Because the airflow is introduced in conjunction with lighting directly above the patient from the airflow delivery apparatus, the airflow is less likely to be obstructed. Thus, the airflow from the airflow delivery apparatus to the return inlet is more laminar and consistent.

The above-described system may also additionally or alternatively comprise a second airflow delivery apparatus positioned above the operating platform. The second airflow delivery apparatus includes a frame and a second plurality of vents. The frame is positioned above the operating platform and includes a channel for receiving airflow. The second plurality of vents is connected to the channel and configured to receive the airflow from the channel and direct the airflow toward a perimeter of the operating platform. The airflow from the frame toward the perimeter and to the return inlet acts as an air curtain surrounding the operating platform that prevents contaminates outside the perimeter of the operating platform from entering an operating field.

The above-described system may also comprise a second return inlet and a return plenum positioned in the base of the operating platform. The return plenum includes a duct, an inlet fan, a discharge outlet, and a particulate filter. The duct is connected to the return inlets. The inlet fan is positioned in the duct and configured to pull airflow into the duct through the return inlets. The discharge outlet is also connected to the duct. The filter is positioned between the discharge outlet and the return inlets so that the airflow from the return inlets to the discharge outlet is filtered. The return plenum enhances laminar airflow around the operating platform by not creating a pressure vacuum, which could disrupt the airflow.

Another embodiment of the invention is a method of providing laminar airflow over an operating table. The method broadly comprises directing airflow toward the operating platform via an airflow delivery apparatus positioned above the operating platform, the airflow delivery apparatus including a lighting assembly configured to direct light toward the operating table, and a plurality of vents positioned along an outer radius around the light source and configured to direct the airflow toward the operating table. The method further comprises extracting airflow from around the operating platform through a return inlet positioned on the base of the operating platform.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is an elevated perspective view of a system for providing laminar airflow over an operating platform constructed in accordance with embodiments of the present invention;

FIG. 2 is a side perspective view of an airflow delivery apparatus, which is included as part of the system of FIG. 1;

FIG. 3A is a side sectional view of an articulating arm of the apparatus of FIG. 2;

FIG. 3B is a sectional view of the articulating arm taken along the line 3B-3B of FIG. 3A;

FIG. 4 is a bottom perspective view of an airflow delivery apparatus of the system of FIG. 1;

FIG. 5 is a perspective view of an operating platform shown with the system of FIG. 1, with the operating platform including a base with a return plenum;

FIG. 6 is an elevated perspective view of a system for providing laminar airflow over an operating platform constructed in accordance with another embodiment of the present invention;

FIG. 7 is a lower perspective view of an airflow delivery apparatus, which is included as part of the system of FIG. 6;

FIG. 8 is a side perspective view of a micro-delivery apparatus of the airflow delivery apparatus of FIG. 7;

FIG. 9 is an elevated perspective view of a system constructed in accordance with yet another embodiment of the present invention;

FIG. 10 is an elevated perspective view of a return plenum that may form part of the system of FIG. 9;

FIG. 11 is a perspective cross-sectional view of the return plenum of FIG. 10; and

FIG. 12 is a flowchart illustrating a method for providing laminar airflow around an operating platform according to embodiments of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

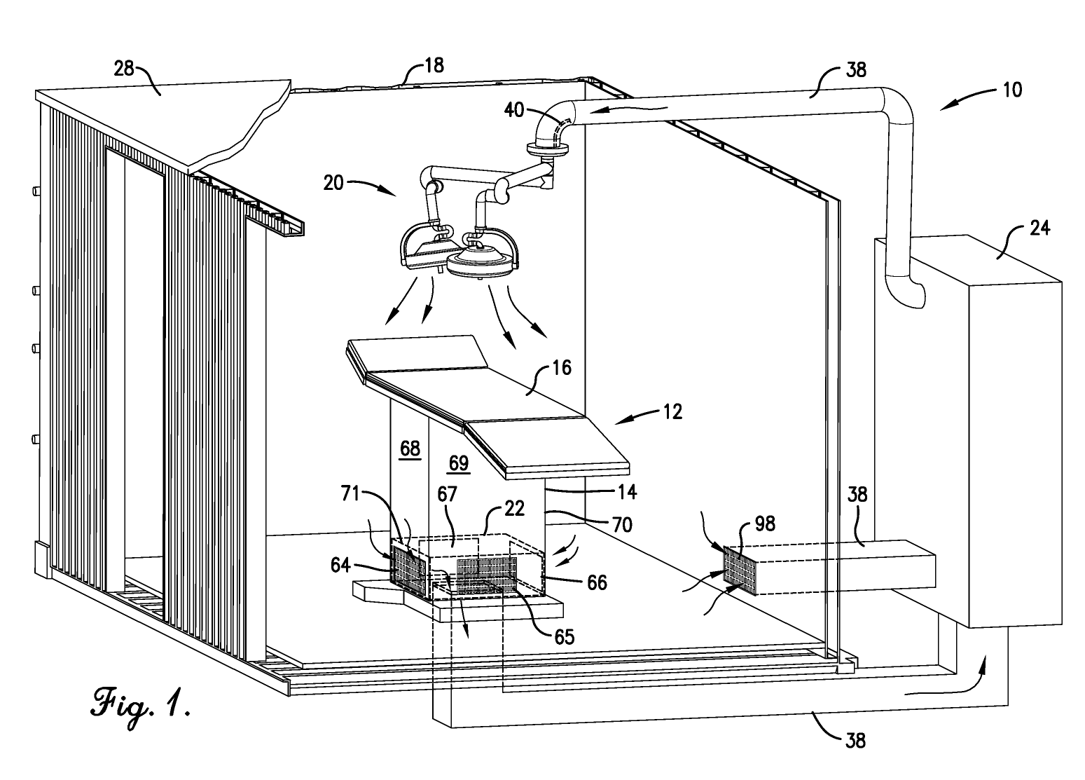

Turning to FIG. 1, a system 10 for providing laminar airflow over an operating platform 12 constructed in accordance with an embodiment of the present invention is illustrated. In certain embodiments, the system 10 broadly comprises the surgical platform 12, an airflow delivery apparatus 20, a return plenum 22, and an air handler 24. The operating platform 12 may be any platform used for performing surgery, such as an operating table or the like. The operating platform 12 includes a base 14 supporting a top surface 16 and may be positioned in a surgical suite 18, such as an emergency room (ER), an operating room (OR), multiple ER/OR rooms, a mobile surgical facility, or the like. In some embodiments, the operating platform 12 may be mobile (e.g., with wheels extending from the base 14), such that the operating platform 12 can be moved into and out of the surgical suite 18 for cleaning, maintenance, and the like. For instance, after performing a surgery, the operating platform 12 may be removed from the surgical suite 18 for cleaning and disinfection. Thereafter, the operating platform 12 may be moved back into the surgical suite 18, where it can be locked down into place for the next surgery. To help facilitate the mobility of the operating platform 12, in some embodiments, the operating platform will include connection components (e.g., hook-ups) for connecting the operating platform 12 with external electrical and air/pneumatic sources.

A patient, or a body part of the patient, may be positioned within an operating field extending above the top surface 16 of the operating platform 12. As used herein, the term “operating field” is used to mean an area on or above the operating platform 12, in which a patient is positioned and in which a surgeon (or other medical personnel) performs surgery (or another medical procedure).

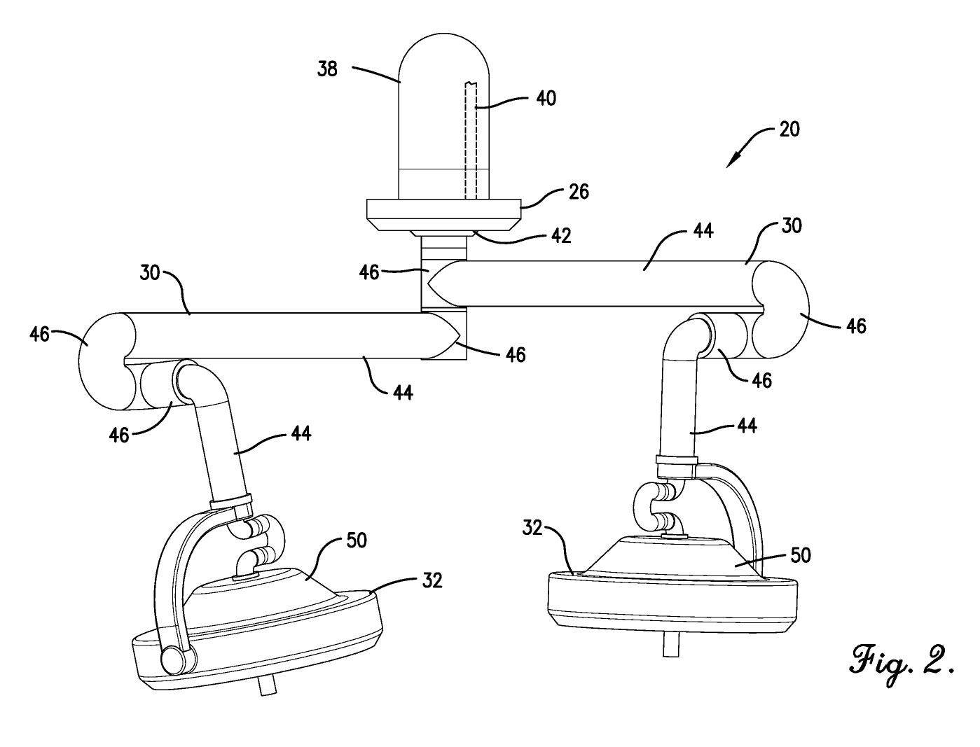

The airflow delivery apparatus 20 may provide and direct both light and airflow toward the top surface 16 of the operating platform 12. Specifically, as discussed in more detail below, the airflow delivery apparatus 20 will be configured to direct a laminar airflow through the operating field while surgery is being performed on a patient. Turning to FIGS. 2-4, the airflow delivery apparatus 20 may include a support 26 attached to a ceiling 28 of the surgical suite 18, an articulating arm 30 attached to the support 26, and a housing 32 attached to the arm 30. The support 26 may be configured to receive filtered airflow via one or more conduit 38 above the ceiling 28 as well as to receive electrical wiring 40. The conduit 38 may be in communication with the return plenum 22, the air handler 24, and/or another source of filtered airflow. The electrical wiring 40 may be one or more wire, cable, or the like, such as a power cord that provides electricity to the air-flow delivery apparatus 20, that is positioned above the ceiling 28. The support 26 may include an opening 42 for receiving the airflow, conduit 38, and/or wiring 40.

While FIG. 1 depicts the support 26 attached to the ceiling 28, it is foreseen that the airflow delivery apparatus 20 may be suspended above the operating platform 12 using other means without departing from the scope of the present invention. Nevertheless, in some embodiments, the airflow delivery apparatus 20 being positioned on the ceiling 28 of the surgical suite 18 may be beneficial so as to provide for a clean, unobstructed airflow to and around the patient. Specifically, the airflow delivery apparatus 20 may be located directly above the patient (as would be positioned on the operating platform 12), such that the area between the patient and the airflow delivery apparatus 20 (e.g., the operating field) can be kept clear for the surgeon to work. This clear space is also beneficial for channeling airflow in a laminar manner, by assuring a clear air passage from the airflow delivery apparatus 20 to the patient and/or to the surgical site of the patient.

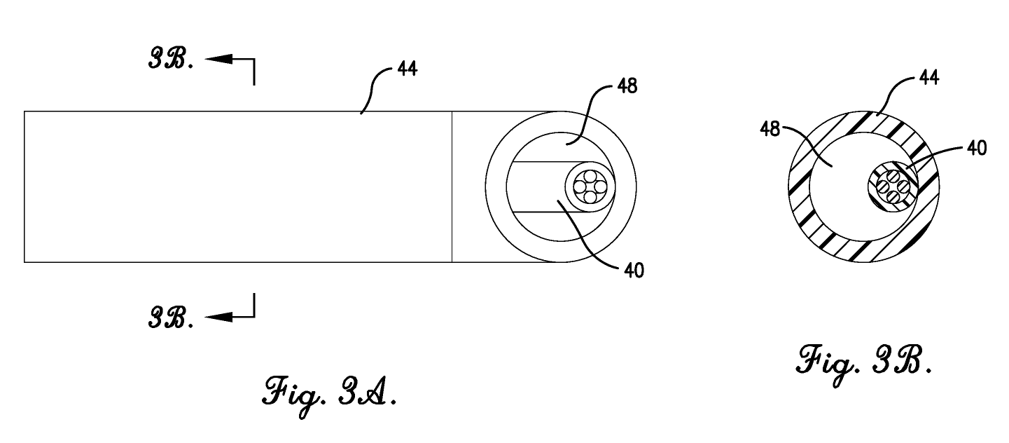

The articulating arm 30 enables the housing 32 to move relative to the operating platform 12 and includes one or more hollow tubes 44 attached to one or more joint 46. The articulating arm 30 may be pivotally attached to the support 26 via one or more joint 46. The one or more hollow tubes 44 may also be connected to each other via the one or more joints 46. As shown in FIG. 3B, the hollow tubes 44 may include a channel 48 that directs the airflow to the housing 32 and that houses the wiring 40. In some embodiments, the hollow tubes 44 (as well as other components of the system 10) may be formed from stainless steel, polyvinyl chloride (PVC), or various other materials that can be easily cleaned and/or disinfected. In some specific embodiments, the hollow tubes 44 may be about 4 to 8 inches in diameter, about 5 to 7 inches in diameter, or 6 inches in diameter.

The housing 32 includes a pressurized air shroud 50, one or more passages 52, a lighting assembly 34, and a plurality of vents 36. The air shroud 50 is in communication with the channel 48 so that air from the channel 48 is directed into the air shroud 50. In some embodiments, the air received by the air shroud 50 (e.g., from the air handler 24) may be received at a volumetric flow rate of about 100 to 200 cubic feet per minute (CFM), about 125 to 175 CFM, or 150 CFM. The passages 52 are in communication with the air shroud 50 and extend from the air shroud 50 to the plurality of vents 36 so that the airflow is directed from the channel 48 to the air shroud 50, and from the air shroud 50 through the passages 52 to the plurality of vents 36.

The lighting assembly 34 is connected to the wiring 40 and directs electricity to one or more light sources 54. The lighting assembly 34 may include one or more drivers (not shown), such as an AC-DC converter, for converting power received from the wiring 40 so that it may power the light sources 54. The light sources 54 may be centered on a bottom surface 56 of the housing 32. The light sources 54 may be any device configured to emit light, such as a bulb, LED, etc.

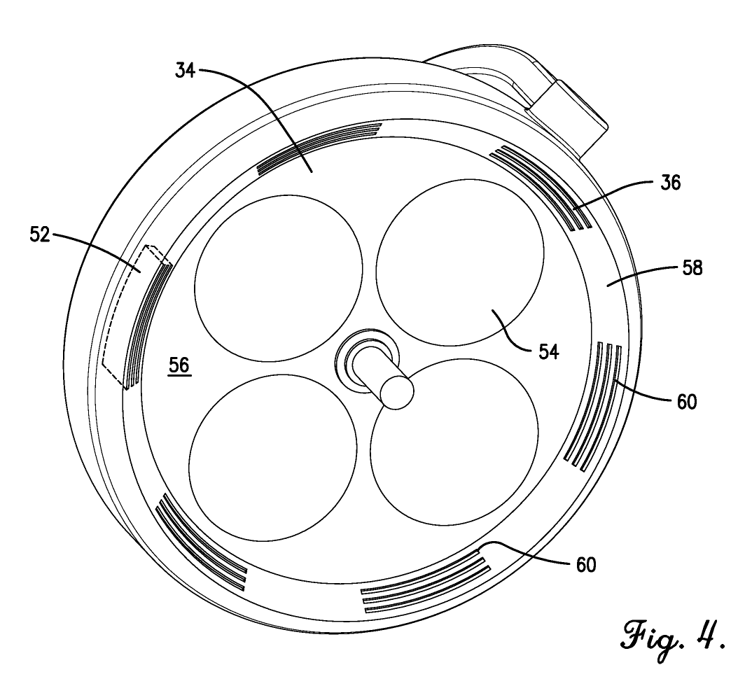

The plurality of vents 36 directs airflow from the passages 52 toward the top surface 16 of the operating platform 12. As shown in FIG. 4, the plurality of vents 36 may be positioned around the light sources 54 along a radius 58 that circumscribes the light sources 54. The vents 36 may include adjustable vanes 60 for modifying the airflow through the vents 36. In some embodiments, the airflow delivery apparatus 20 will be configured such that the vents 36 emit airflow at a volumetric flow rate of about 10 to 100 CFM, about 20 to 70 CFM, or about 30 to 50 CFM. As a result, the airflow delivery apparatus 20 can direct a laminar airflow through the operating field on onto the patient so as to create a 30 to 50 CFM clean air screen and/or vertical air curtain functioning to separate the patient from contaminants found natively in the surgical suite 18, as well as generated from the patient's own dermis in the course of a surgical procedure.

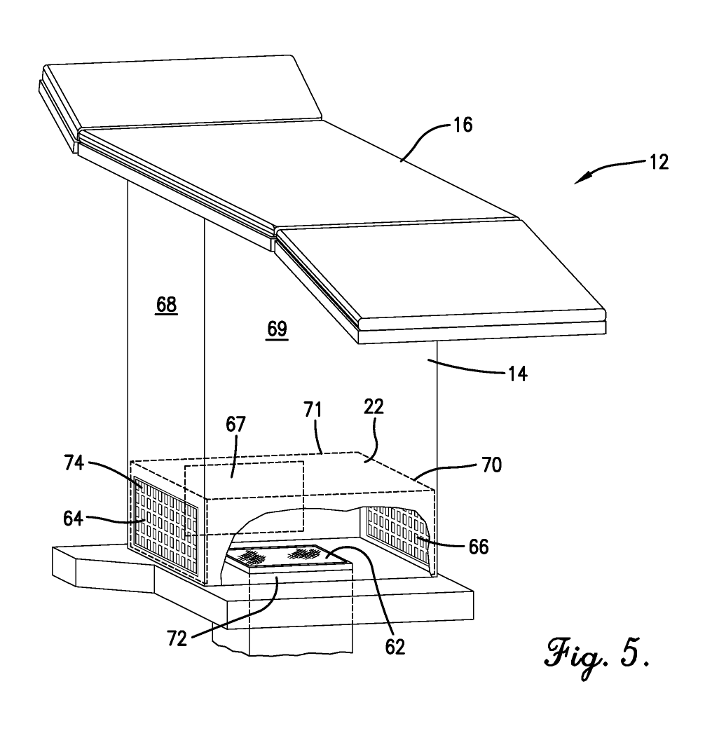

Turning to FIG. 5, the return plenum 22 is configured to receive the airflow around the operating platform 12 and is positioned in the base 14 of the operating platform 12. The return plenum 22 may present a box-like structure and includes a filter 62, such as a high-efficiency particulate air (HEPA) filter, one, two, three, four, or more return (e.g., return inlets 64, 65, 66, 67) located on the sides 68, 69, 70, 71 of the base 14 of the operating platform 12, and an outlet 72. In some embodiments, the return plenum 22 and/or the return inlets 64, 65, 66, 67 may be spaced above the floor of the surgical suite 18. For example, in some embodiments, the plenum 22 and/or the return inlets 64, 65, 66, 67 may be spaced above the floor about 2 to 12 inches, about 4 to 10 inches, or about 8 inches.

The filter 62 is configured to filter air traveling into and/or through the return plenum 22. As used herein, the term filtering is generally meant to comprise HEPA filtering, which broadly provides for air to be filtered of generally any type of particulate that may exist in the operating suite 18 (e.g., dust, microbials, etc.) and/or that may be generated during surgery (e.g., squames). In some embodiments, the filter 62 may be easily removable/re-insertable from/to the return plenum 22 so as to facilitate efficient cleaning and replacement of the filter 62. The return inlets 64, 65, 66, 67 may include one or more louvers 74 for modifying the airflow traveling into the inlets 64, 65, 66, 67. The airflow from the vents 36 travels through the operating field above the top surface 16 of the operating platform 12 and then is drawn into the negatively-pressurized return plenum 22 through the return inlets 64, 65, 66, 67. The filter 62 may be positioned between the inlets 64, 65, 66, 67 and the outlet 72 so that the air is filtered before exiting through the outlet 72. The outlet 72 may be in communication with the conduit 38 and/or the air handler 24 so as to re-circulate the airflow to the airflow delivery apparatus 20.

The air handler 24 is configured to condition fresh airflow and/or airflow from the return plenum 22 and direct the conditioned airflow back to the airflow delivery apparatus 20. The air handler 24 may include one or more of: HEPA filters, fresh air inlets, air conditioning units (i.e., to reduce the temperature of the airflow provided to the airflow delivery apparatus 20), heaters (i.e., to increase the temperature of the airflow provided to the airflow delivery apparatus 20), humidifiers, de-humidifiers, and humidity control systems.

An exemplary way to use the above-described system 10 will now be described. The air handler 24 may initially condition airflow (e.g., HEPA filter, add fresh air, modify the temperature, modify the humidity, etc.) and direct it through conduit 38 to the airflow delivery apparatus 20 via one or more blowers (not shown). The conditioned airflow travels through conduit 38 and to the support 26 of the airflow delivery apparatus 20. The airflow then travels through the opening 42 of the support 26 and through the channel 48 of the articulating arm 30 to the air shroud 50 of the housing 32. The airflow then passes the air shroud 50 and is directed through the passages 52 of the housing 32 to the vents 36.

The vanes 60 of the vents 36 direct the airflow toward the operating platform 12 (e.g., at 30 to 50 CFM), and the return plenum 22 receives the airflow traveling down around the operating platform 12 through the return inlets 64, 65, 66, 67. The airflow may be pulled into the plenum 22 via fans (not shown) of the air handler 24 and/or the return plenum 22. The air handler 24 then conditions and/or filters the airflow from the return plenum 22 and directs the airflow back to the airflow delivery apparatus 20.

The system 10 causes the airflow travelling from the vents 36 to the return inlets 64, 65, 66, 67 to be laminar (i.e., smoothly with reduced, minimized, and/or non-existent turbulence or eddies), which minimizes the chance for squames or other harmful particulates from entering the surgical site (e.g., an open wound) of the patient. In more detail, the airflow emitted by the airflow delivery apparatus 20 is configured to be generally smooth, with consistent pressure and velocity. Such airflow is directed towards and passes through the operating field and over the patient being operated on within the operating field. In some embodiments, the airflow will be directed specifically over the surgical site of the patient. As the airflow passes through the operating field, the airflow remains laminar (e.g., without turbulence, eddies, swirling) due in part to the return plenum 22 on the base 14 of the operating platform 12 creating a negatively pressurized duct within which the airflow can be extracted. As a result, embodiments of the present invention minimize the exposure time of the patient to particulates in the air, and inhibits random turbulent flow of entrained squames that might linger around the patient and potentially enter the surgical site of the patient. As such, embodiments of the present invention can reduce the probability of re-entrainment of squames in a surgical wound.

For mobile surgical suites 18 located in hot and humid climates, the system 10 may be configured to keep the space around the operating platform 12 cooler. This enables the air away from the operating platform 12 in the surgical suite 18 to be warmer, which reduces a load on the air handler 24.

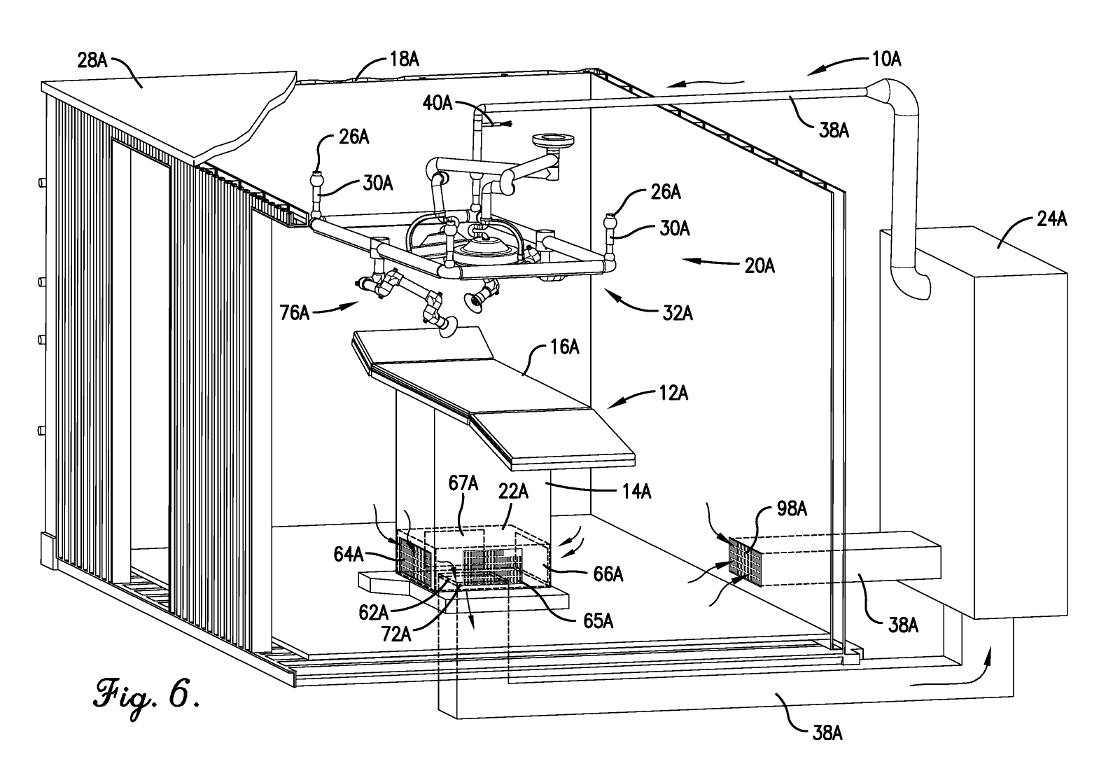

A system 10A constructed in accordance with another embodiment of the present invention is shown in FIG. 6. The system 10A may comprise similar components as system 10; thus, the components of system 10A that correspond to similar components in system 10 have an ‘A’ appended to their reference numerals.

The airflow delivery apparatus 20A of the system 10A additionally or alternatively includes a plurality of supports 26A connected to the ceiling 28A, a plurality of arms 30A attached to the supports 26A, a frame 32A attached to the arms 30A, a lighting assembly 34A supported on the frame 32A, a plurality of vents 36A located on the frame 32A, and one or more micro-delivery devices 76A. One or more of the supports 26A are configured to receive filtered airflow via one or more conduit 38A above the ceiling 28A. One or more of the supports 26A may also be configured to receive electrical wiring 40A. The one or more supports 26A may be configured to receive the airflow and/or wiring 40A through an opening 42A.

The plurality of arms 30A are pivotably attached to the plurality of supports 26A via one or more joints 46A and are configured to linearly expand, such as telescopically. The joints 46A may be located at each end of the arms 30A so that the arms 30A are also pivotally attached to the frame 32A. The joints 46A may be gimbals, ball-and-socket joints, or the like. The arms 30A may be configured to linearly expand via a hydraulic, electrical, and/or mechanical system. One or more of the arms 30A may include a channel 48A for receiving the electrical wiring 40A and/or the airflow from the one or more of the plurality of supports 26A having an opening 42A. The channel 48A may be configured to direct the airflow and/or wiring 40A to the frame 32A.

The frame 32A is pivotably connected to the plurality of arms 30A and may have the same size and/or shape as a perimeter of the top surface 16A of the operating platform 12A. The frame 32A includes hollow members 44A having passages 52A for housing the electrical wiring 40A and directing the airflow from the plurality of arms 30A to the lighting assembly 34A and the plurality of vents 36A. In some embodiments, the air received by the frame 32A (e.g., from the air handler 24A) may be received at a volumetric flow rate of about 100 to 200 CFM, about 125 to 175 CFM, or 150 CFM. Furthermore, in some embodiments, the hollow members 44A may be formed from stainless steel and may be about 4 to 8 inches in diameter, about 5 to 7 inches in diameter, or 6 inches in diameter. The frame 32A may be manually or electrically repositionable so that it can be suspended at a plurality of orientations relative to the operating platform 12A.

In general, the airflow delivery apparatus 20A will be positioned on the ceiling 28A of the surgical suite 18A so as to provide for a clean, unobstructed airflow around the patient. Specifically, the airflow delivery apparatus 20A may be located directly above the patient (as positioned on the operating platform 12A), such that the area between the patient and the airflow delivery apparatus 20A (e.g., the operating field) can be kept clear for the surgeon to work. This clear space is also beneficial for channeling airflow in a laminar manner around the operating field so as to create an air screen to shield the patient. Specifically, in some embodiments, the frame 32A will configured with a size and shape that corresponds with (e.g., matches) the size and shape of the operating platform 12A so as to emit a laminar airflow around the operating field to separate the patient from contaminants found throughout the surgical suite 18. For example, in some specific embodiments, the operating platform 12A will have dimensions of about three feet by six feet (while the surgical suite 18 itself may have dimensions about twenty feet by thirty feet). As such, the frame 32A of the airflow delivery apparatus 20A can similarly have a size of about three feet by six feet so as to mimic the size of the operating platform 18 to thereby create a laminar airflow shield around the operating platform 18.

The lighting assembly 34A is connected to the wiring 40A and directs electricity to one or more light sources 54A. The lighting assembly 34A may include one or more driver (not shown), such as an AC-DC converter, for converting power received from the wiring 40A so that it may power the one or more light sources 54A. The one or more light sources 54A may be positioned on a bottom surface 56A of the frame 32A. The one or more light sources 54A may be variable light-emitting diodes (LEDs) and/or germicidal lighting, such as ultraviolet germicidal irradiation lights (e.g., UV-C). In some embodiments, the ultraviolet germicidal irradiation lights may be configured to emit ultraviolet light with wavelengths between 200-280 nanometers. When using such ultraviolet germicidal irradiation lights, the surgeons and/or the patient (as well as other personnel within the surgical suite 18) may be required to wear protective clothing and eyewear, as such light may damage the skin and/or the eyes. In some specific embodiments, the lighting assembly 34A may be configured to be activated only when the surgical suite 18 is unoccupied so as to kill unwanted microorganisms without causing harm to personnel.

In even further embodiments, the ultraviolet germicidal irradiation lights may be positioned within the conduits 38A so as provide additional germicidal action to the air handler 24. Such embodiments may be beneficial, as the ultraviolet germicidal irradiation lights within the conduits 38A could be run twenty-four hours a day without fear of harm to medical personnel or patients. In further embodiments, the ultraviolet germicidal irradiation lights may be positioned so as to direct ultraviolet light on the air handler's 24 condenser and coil units to prevent mold and bacteria growth, particularly in hot and humid environments.

The plurality of vents 36A direct airflow from the passages 52A of the frame 32A to the perimeter of the top surface 16A of the operating platform 12A. The plurality of vents 36A may be alternatingly positioned with the one or more light sources 54A. The vents 36A may include vanes 60A for modifying the airflow through the vents 36A. In some embodiments, the airflow delivery apparatus 20A will be configured such that the vents 36A emit airflow at a volumetric flow rate of about 10 to 100 CFM, about 20 to 70 CFM, or about 30 to 50 CFM. As a result, the airflow delivery apparatus 20A can direct a laminar airflow in the shape of an air shield/screen or curtain around the operating field at a volumetric flow rate of about 30 to 50 CFM. Such laminar air flow is configured to provide a clean air shield/screen and/or vertical air curtain that functions to separate the operating field from contaminants found natively in the surgical suite 18, as was previously described.

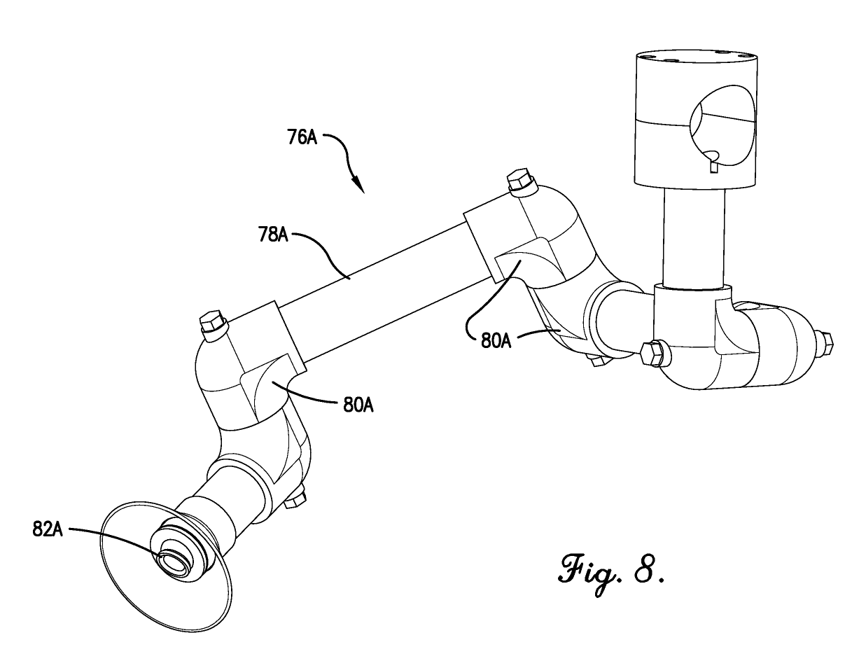

Turning to FIG. 8, the micro-delivery devices 76A are configured to permit manually-adjustable airflow and may provide airflow laterally across the operating field on the top surface 16A in order to not entrain squames when surgery is performed. The micro-delivery devices 76A may be in communication with one or more of the vents 36A and may comprise one or more articulating tubes 78A, one or more joints 80A, and an outlet valve 82A. The articulating tube 78A attaches to the frame 32A where a vent 36A is located so that airflow is directed through the tube 78A and to the outlet valve 82A. The articulating tubes 78A may be manually adjustable by a user (e.g., a surgeon), such that the micro-delivery devices 76A can be positioned and repositioned as needed within or adjacent to the operating field. For example, the outlet of the micro-delivery device 76A may be positioned so as to direct airflow directly across the surgical site of the patient. The outlet valve 82A is generally positioned at the end of the micro-delivery device 76A (e.g., at the outlet) so as to form a snorkel. The outlet valve 82A may be configured to be adjustable so as to control the speed, temperature, volume, and direction of the airflow as the airflow exits the micro-delivery devices 76A. The joints 80A permit the micro-delivery device 76A to be positioned in various configurations and positions, as may be required by the user (e.g., a surgeon). In some additional embodiments, the micro-delivery devices 76A may include an adjustable/focusable light source (e.g., positioned adjacent to or on the outlet valve 82A) to permit the surgeon to direct light where needed during surgery (e.g., directly at the surgical site on the patient).

An exemplary way to use the above-described system 10A will now be described. The airflow delivery apparatus 20A may be used with the airflow delivery apparatus 20 or with standard surgical lighting. The airflow delivery apparatus 20A receives filtered air from one or more conduit 38A, the air handler 24A, and/or the return plenum 22A. The filtered airflow travels through the opening 42A of one or more of the supports 26A and through the channel 48A of one or more of the arms 30A. The channel 48A of one or more of the arms 30A directs the airflow to the frame 32A. The airflow travels through the passages 52A of the frame 32A and out the vents 36A. The vanes 60A may be used to adjust the airflow emitted from the vents 36A and direct it at a perimeter of the top surface 16A of the operating platform 12A. The frame 32A may be repositioned (e.g., via actuation of the arms 30A) to a desired orientation relative to the operating platform 12A. Thus, the position of the airflow delivery apparatus 20A can be changed as necessary to ensure that the generated air curtain appropriately encloses the operating field. As such, the airflow from the vents 36A can be configured to create an air curtain that surrounds the patient and personnel to prevent contaminants from above and outside the perimeter of the top surface 16 from entering the into the operating filed. By preventing contaminants from entering the operating field, the chance for contaminants (e.g., squames) or other particulates from entering the surgical site of the patient can be minimized.

Some of the airflow may also travel to the one or more micro-delivery device 76A. The airflow exits one or more vent 36A and enters the articulating tube 78A. The airflow travels through the tube 78A, and if the outlet valve 82A is open, the airflow is emitted from the micro-delivery device 76A in the direction provided by the outlet valve 82A. The airflow may be emitted from the outlet valve 82A in any direction, as positioned by the user (e.g., the surgeon). For instance, the airflow from the outlet valve 82A may be emitted laterally over the operating field on the top surface 16 of the operating platform 12A, or over the operating area on the patient. Lateral airflow may be used to prevent squames and other contaminates from contaminating an open wound on a patient positioned on the operating platform 12A.

Airflow around and below the top surface 16A is then drawn into the inlets 64A, 65A, 66A, 67A of the return plenum 22A. The airflow may then be filtered via the filter 62A and/or the air handler 24A and returned to the airflow delivery apparatus 20A via one or more conduit 38A.

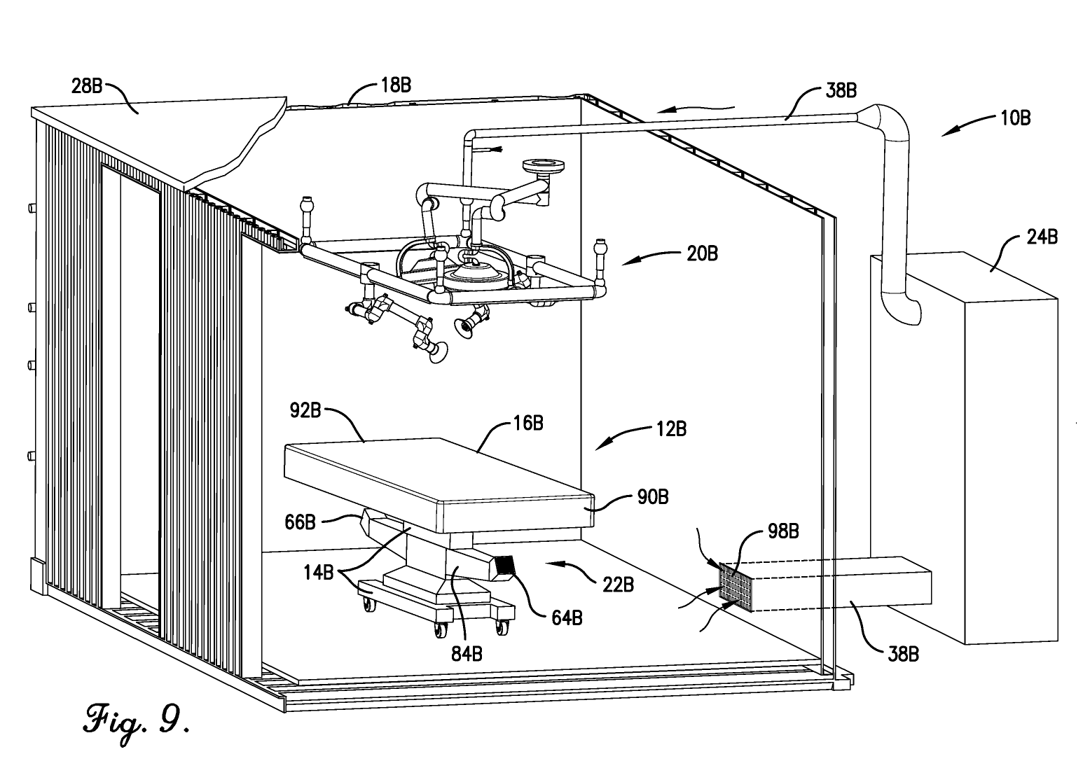

A system 10B constructed in accordance with another embodiment of the present invention is shown in FIG. 9. The system 10B may comprise similar components as system 10A; thus, the components of system 10B that correspond to similar components in system 10A have a ‘B’ appended to their reference numerals.

The return plenum 22B of the system 10B additionally or alternatively includes a duct 84B and a pair of inlet fans 86B, 88B. The return inlets 64B, 66B of plenum 22B are positioned at each end 90B, 92B of the operating platform 12B below the top surface 16B. The duct 84B is connected to and extends from one return inlet 64B to the other return inlet 66B. The duct 84B diverges away from the inlets 64B, 66B toward a center region 94B. The diverging duct 84B is configured to prevent airflow from forming a vacuum in the plenum 22B, which could possibly create an unwanted back pressure that would affect the laminar airflow from the vents 36B. The inlet fans 86B, 88B are positioned in the duct 84B next to each inlet fan 64B, 66B and are configured to pull airflow into the duct 84B through the inlets 86B, 88B. It is foreseen that the plenum 22B may include any number of fan configurations, such as a configuration having only one fan positioned adjacent the outlet 72B, without departing from the scope of the present invention. Such fans (or additional fans) may also be positioned elsewhere within the duct 84B so as to ensure laminar airflow. The fans may, according to various embodiments, be powered via electricity provided through the connection components (e.g., hook-ups) on the base 14 of the operating platform 12.

The filter 62B (which may comprise a HEPA filter) is positioned between the discharge the inlets 64B, 66B and the outlet 72B so that the airflow from the inlets 64B, 66B to the discharge outlet 72B is filtered. The filter 62B may be positioned just above the outlet 72B and below the center region 94B of the duct 84B. However, it is foreseen that the plenum 22B may include any number of filter configurations, such as having two filters positioned adjacent the inlets 64B, 66B, without departing from the scope of the present invention. Furthermore, certain embodiments of the plenum 22B may include more than the two inlets 64B, 66B. For instance, in some embodiments, the plenum 22B may be cross-shaped so as to include second duct extending perpendicular to the the duct 84B. The second duct may include a third and a fourth return inlet (not shown) positioned 90 degrees away from the return inlets 64B, 66B.

The discharge outlet 72B is positioned between the inlets 64B, 66B and includes one or more louvers 96B. The louvers 96B may direct the airflow to one or more conduit 38B and/or back into the surgical suite 18B in the direction of other return plenums 98B positioned on lower portions of the walls of the surgical suite 18B.

An exemplary way to use the above-described system 10B will now be described. The inlet fans 86B, 88B are configured to pull airflow into the plenum 22B at a desired speed, such as about two meters per second (about 6.56 feet per second). The diverging duct 84B is configured to cause the velocity of the airflow to reduce. For example, the velocity of the airflow in the duct 84B may be reduced to about 1.2 meters per second (about 3.94 feet per second) by the time the airflow reaches the center region 94B of the duct 84B. At the center region 94B, airflow from the inlets 64B, 66B collides and drops down toward the filter 62B.

For airflow to pass through the filter 62B, the airflow in the center region 94B requires pressure potential or head. The pressure potential builds as the velocity of the airflow drops, and the air fills the entire center region 94B above the filter 62B. The airflow above the filter 62B passes through the filter 62B once it achieves enough pressure potential to pass through the filter 62B. The airflow exits through the outlet 72B at a slow velocity, such as around 0.1 to 0.3 meters per second (0.33 to 0.98 feet per second). The louvers 96B may be angled at 45 degrees to enable low velocity air to disperse into the surgical suite 18 and then flow toward pre-existing wall-mounted return plenums 98B without entering the operating field around the patient.

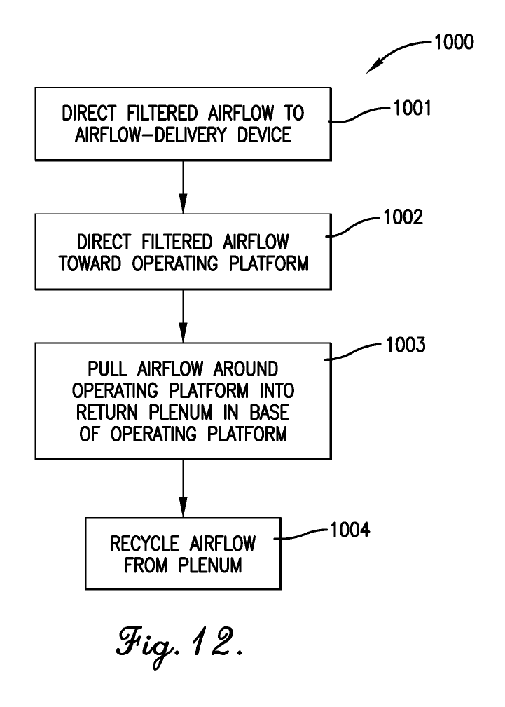

In addition to, or in conjunction with, the components of the systems 10, 10A, 10B discussed above, embodiments of the present invention include methods for providing laminar airflow. For example, the flow chart of FIG. 12 depicts the steps of an exemplary method 1000 of providing laminar airflow over an operating platform. In some implementations, the functions noted in the various blocks may occur out of the order depicted in FIG. 12. For example, two blocks shown in succession in FIG. 12 may in fact be executed substantially concurrently, or the blocks may sometimes be executed in the reverse order depending upon the functionality involved. In addition, some steps may be optional.

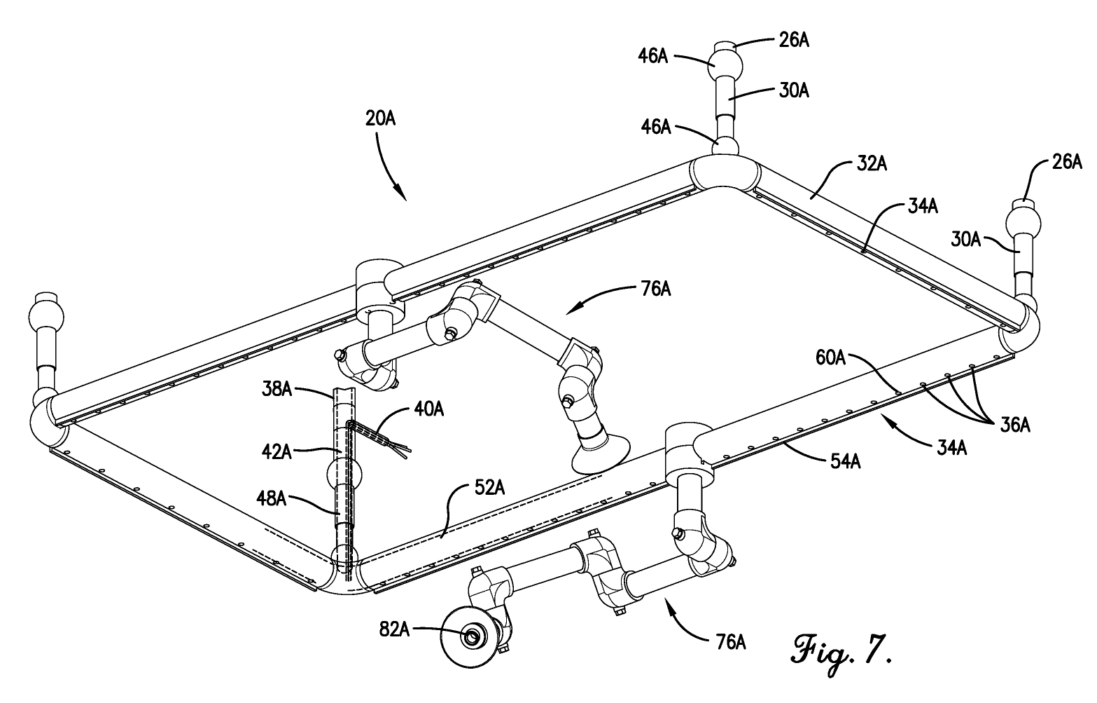

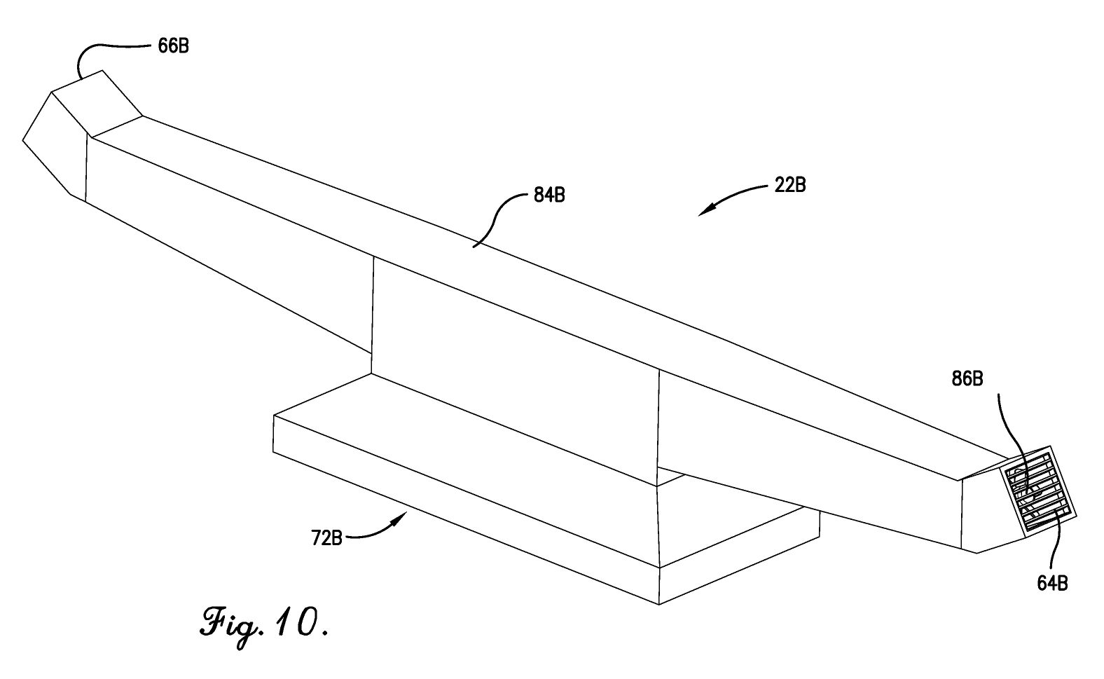

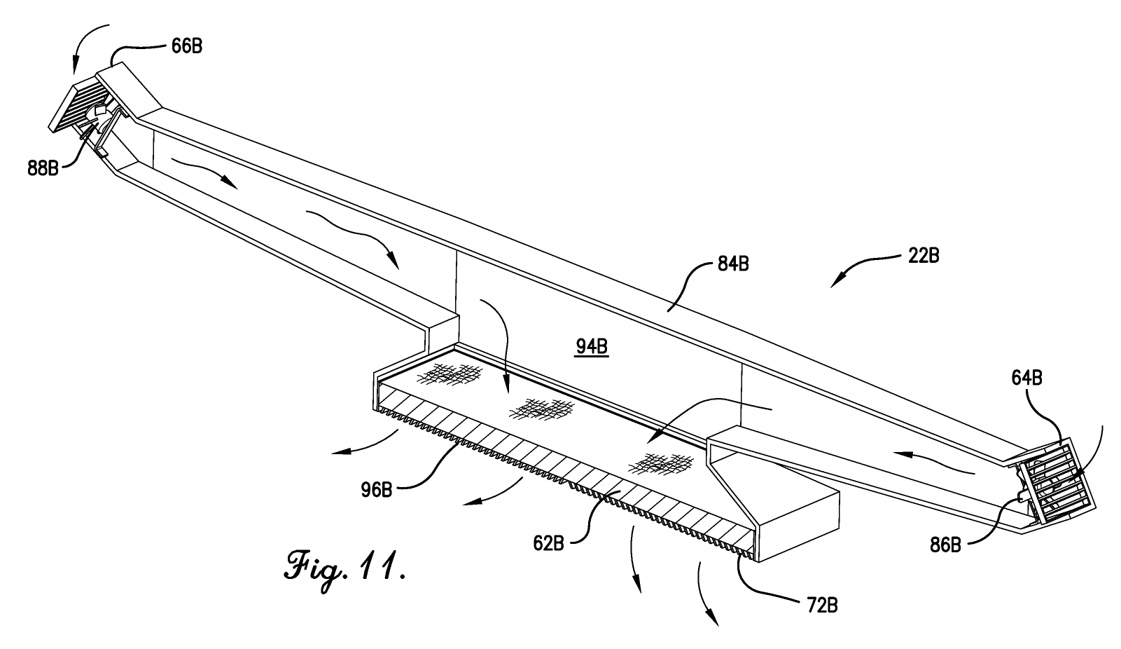

The method 1000 is described below, for ease of reference, as being executed by exemplary devices and components introduced with the embodiments illustrated in FIGS. 1-11. In some specific embodiments, for example, the steps of the method 1000 may be performed by the components of the systems 10, 10A, 10B through the utilization of processors, transceivers, hardware, software, firmware, or combinations thereof. However, some of such actions may be distributed differently among such devices or other devices without departing from the spirit of the present invention. Control of the systems 10, 10A, 10B may also be partially implemented with computer programs stored on one or more computer-readable medium(s). The computer-readable medium(s) may include one or more executable programs stored thereon, wherein the program(s) instruct one or more processing elements to perform all or certain of the steps outlined herein. The program(s) stored on the computer-readable medium(s) may instruct processing element(s) to perform additional, fewer, or alternative actions, including those discussed elsewhere herein.

Referring to step 1001, filtered airflow from the air handler 24 is directed to the airflow delivery apparatus 20, 20A via one or more conduit 38. The filtered airflow may be conditioned by cooling, heating, dehumidifying, humidifying, or the like via the air handler 24. The conduit 38 may be positioned in the ceiling 28 of the surgical suite 18.

Referring to step 1002, once the airflow reaches the airflow delivery apparatus 20, 20A, it is directed toward the operating platform 12 via the airflow delivery apparatus 20. This step may include directing airflow to the operating platform 12 using both apparatus 20 and apparatus 20A. The airflow may be directed toward a perimeter of the top surface 16A via the airflow delivery apparatus 20A. This step may include positioning the airflow delivery apparatus 20, 20A in a desired position via the articulating arm 30 and/or the jointed arms 30A. This step may also include directing the airflow to the operating platform 12A via the one or more micro-delivery device 76A.

Referring to step 1003, the airflow around the operating platform 12 is pulled in through the one or more return inlets 64, 65, 66, 67, 64B, 66B and into the return plenum 22, 22B positioned in the base 14. This produces laminar airflow over the operating platform 12. The airflow may be drawn into the plenum 22, 22B via one or more fan of the air handler 24 and/or the inlet fans 86B, 88B.

Referring to step 1004, the airflow in the plenum 22, 22B is recycled. Such recycling may include filtering particulates (e.g., squames) and other contaminates from the airflow. The airflow may be pushed down through the filter 62, 62B in the plenum or through a filter in the air handler 24. As such, during such recycling of step 1004, the airflow can be filtered from all particulates that may have been collected (e.g., squames) as the airflow traveled from the airflow delivery apparatus 20, 20A to the plenum 22, 22B. The airflow may be mixed with fresh air from outside the surgical suite 18 and together/separately conditioned and/or filtered. Once the airflow has been conditioned and/or filtered, the airflow may be directed back to the airflow delivery apparatus 20, 20A via the one or more conduit 38.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for providing laminar airflow over an operating platform having a base, the system comprising:
an airflow delivery apparatus positioned above the operating platform and including—
a lighting assembly configured to direct light towards the operating platform, and
a plurality of vents configured to direct airflow toward the operating platform; and
a return inlet positioned on the base of the operating platform and configured to receive airflow from around the operating platform.

2. The system of claim 1, the airflow delivery apparatus including a frame positioned above the operating platform that supports the lighting assembly and the plurality of vents.

3. The system of claim 2, the airflow delivery apparatus including a plurality of supports configured to receive air, and a plurality of arms pivotably attached to the supports and configured to linearly expand, at least one of the arms including a channel for directing the airflow from its respective support to the plurality of vents.

4. The system of claim 1, the lighting assembly of the airflow delivery apparatus including an ultraviolet germicidal irradiation light source.

5. The system of claim 2, wherein the frame of the airflow delivery apparatus forms a shape that corresponds with the perimeter of the operating platform.

6. The system of claim 1, wherein the return inlet is a first return inlet and is positioned on a first end of the operating platform, further comprising—
a second return inlet positioned on the base on a second end of the operating platform and configured to receive airflow around the operating platform, and
a return plenum positioned in the base of the operating platform, the return plenum including a duct extending from the first return inlet to the second return inlet.

7. The system of claim 6, the return plenum including louvers positioned in the first return inlet and the second return inlet for modifying airflow entering the return plenum.

8. The system of claim 6, the return plenum including an inlet fan positioned in the duct and configured to pull airflow into the duct.

9. The system of claim 6, the return plenum including a discharge outlet connected to the duct, and a filter positioned between the discharge outlet and the return inlet and the second return inlet so that the airflow travelling through the discharge outlet is filtered.

10. The system of claim 9, wherein the airflow delivery apparatus and the discharge outlet are connected via one or more conduits.

11. The system of claim 9, wherein the duct diverges from the first return inlet and the second return inlet toward a center region of the duct.

12. The system of claim 1, the airflow delivery apparatus including a support configured to receive the airflow and electrical wiring, an articulating arm connected to the support and having a channel for housing the electrical wiring and directing the airflow, and a housing connected to the articulating arm and supporting the light assembly and the plurality of vents, the housing having passages that direct the airflow received from the channel of the articulating arm to the plurality of vents.

13. The system of claim 1, wherein the airflow delivery apparatus is configured to generate a laminar airflow over a patient positioned on a top of the operating platform, wherein the laminar airflow minimizes exposure time of the patient to harmful particulates present in the environment, thereby reducing the probability of re-entrainment in a surgical wound.

14. A system for providing laminar airflow over an operating platform having a top surface and a base, the system comprising:
an airflow delivery apparatus positioned above the operating platform and including—
a plurality of supports configured to secure the airflow delivery apparatus above the operating platform,
a plurality of arms pivotably attached to the plurality of supports and configured to linearly expand,
a frame pivotably connected to the plurality of arms,
a lighting assembly positioned on the frame and configured to direct light toward the operating platform, and
a plurality of vents positioned along the frame and configured to direct airflow toward the operating platform; and
a return inlet positioned on the base of the operating platform and configured to receive airflow.

15. The system of claim 14, the airflow delivery apparatus including a manually-adjustable micro-delivery device attached to and extending from the frame and including an outlet valve configured to deliver airflow.

16. The system of claim 15, the micro-delivery device including an articulating tube.

17. The system of claim 14, the frame having a same shape as a perimeter of the top surface of the operating platform.

18. The system of claim 14, wherein the airflow delivery apparatus is configured to generate a laminar airflow over a patient positioned on a top of the operating platform, wherein the laminar airflow minimizes exposure time of the patient to harmful particulates present in the environment, thereby reducing the probability of re-entrainment in a surgical wound.

19. A method for providing laminar airflow over an operating platform having a base, the method comprising the steps of:
directing airflow toward the operating platform via an airflow delivery apparatus positioned above the operating platform, wherein the airflow delivery apparatus includes—
a lighting assembly configured to direct light toward the operating platform, and
a plurality of vents and configured to direct the airflow toward the operating table; and
pulling airflow from around the operating platform through a return inlet positioned on the base of the operating platform.

20. The method of claim 19, wherein the return inlet is part of a return plenum that comprises a fan, and further including filtering the airflow from the return plenum via a filter, and directing the filtered airflow to the airflow delivery apparatus via one or more conduits.
